(19) United States
(12) Patent Application Publication
(10) Pub. No.: US 2024/0191317 A1
(43) Pub. Date: Jun. 13, 2024

(54) METHOD FOR EFFICIENTLY REMOVING CU IN ELECTRIC FURNACE STEELMAKING WITH REGENERATED STEEL RAW MATERIALS

(71) Applicants: University of Science and Technology Beijing, Beijing (CN); Liaoning Academy of Materials, Shenyang (CN)

(72) Inventors: Guangsheng WEI, Beijing (CN); Rong ZHU, Beijing (CN); Xinping MAO, Beijing (CN); Shuize WANG, Beijing (CN); Chengjin HAN, Beijing (CN); Kai DONG, Beijing (CN); Chao FENG, Beijing (CN); Xin LI, Beijing (CN)

(73) Assignees: University of Science and Technology Beijing, Beijing (CN); Liaoning Academy of Materials, Shenyang (CN)

(21) Appl. No.: 18/463,301

(22) Filed: Sep. 8, 2023

(30) Foreign Application Priority Data
Dec. 8, 2022 (CN) 202211569281.3

(51) Int. Cl. C21C 7/072; C21C 7/10

(52) U.S. Cl. CPC C21C 7/072; C21C 7/10

(57) ABSTRACT

A method for efficiently removing Cu in electric furnace steelmaking with regenerated steel raw materials comprises removing Cu in the electric furnace steelmaking and removing Cu deeply in RH/VOD steelmaking. The removing Cu in electric furnace steelmaking comprises removing Cu by spraying CaO—CaCl₂—O₂ in stages in the electric furnace steelmaking; the removing Cu deeply in the R/VOD steelmaking comprises removing Cu deeply by dynamically blowing CaCl₂—O₂ based on vacuum degree. Cu removing and Cu removing deeply are performed in the electric furnace steelmaking and the RH/VOD refining process based on the Cu removal principle of selective chlorination by high-oxygen-potential microcells manufactured in electric furnace steelmaking molten pool and on the RH/VOD refined steel liquid level and the high-vacuum smelting environment in the RH/VOD refining process fully utilized; the cost is low, the copper removing efficiency is high, and large-scale industrial production are facilitated.

### CROSS-REFERENCE TO RELATED APPLICATIONS

This application claims priority to Chinese Patent Application No. 20221156281.3 filed on Dec. 8, 2022. The content of the aforementioned application, including any intervening amendments thereto, is incorporated herein by reference.

### TECHNICAL FIELD

The present disclosure belongs to the technical field of electric furnace steelmaking, and relates to a method for efficiently removing Cu in electric furnace steelmaking with regenerated steel raw materials.

### BACKGROUND

In related art, it is an urgent need to reduce the consumption of fossil resource in the industry of steel. Compared with the steelmaking of blast furnace-converter, every 1 ton of regenerated steel raw materials (commonly known as steel scrap) can save about 1.5-1.7 tons of iron ore and reduce CO₂ emissions by 1.2-1.4 tons, which makes the development of electric furnace short-process steelmaking more concerned.

Especially for electric furnace short-process steelmaking, the oxygen potential of Cu in regenerated steel raw materials is higher than that of Fe, so it is difficult to effectively remove Cu through oxidation in the steelmaking. Cu will be used as residual elements enriched in steel during recycling process of regenerated steel raw materials, leading to excessively high residual element Cu content in the obtained smelting molten steel, and resulting in “copper brittleness” which will seriously affect the quality of steel products and the effective utilization of regenerated steel raw materials.

Currently, “copper brittleness” can be prevented by reducing the content of residual elements in molten steel by diluting, or by adding alloying elements in combination of cold rolling and hot rolling, or by controlling the source, or by removing Cu with a physical method, or with a chemical method. However, these solutions have more or less various problems.

For example, Chinese application CN103468862A discloses an all-iron high-efficiency steelmaking method using molten iron added to pig iron in an electric furnace. In this method, the residual element content in molten steel is diluted effectively by adding molten iron through the door of the electric furnace and feeding pig iron through a charging channel.

Chinese application CN101538635A discloses a method for controlling nitrogen and residual elements in low-carbon Al-killed steel for cold rolling produced by an electric furnace. In this method, the residual elements in molten steel are diluted by adding direct reduced iron.

Therefore, although the above two Chinese application can reduce the residual element content of molten steel by dilution, the problem of Cu removal from molten steel is not solved, and carbon emissions in the electric furnace steelmaking is increased.

Chinese application CN110819906A discloses a method for improving the deep-drawing property of cold-rolled steel strip deteriorated by residual elements Cu, As, and Sn. In this method, S and Ti elements are added to cold-rolled deep-drawing steel containing residual elements such as Cu, and hot-rolling and cold-rolling processes are used to improve the deep-drawing property of cold-rolled strip steel by reducing the influence of residual elements. However, this method is only effective for steels with low Cu content. In addition, this method does not really reduce the content of residual elements in steel, and cannot solve the problem of enrichment of Cu residual elements caused by recycling scrap steel.

Chinese patent CN114317884A discloses a method for regulating the content of residual elements used in electric furnace smelting of all scrap steel. The method classifies scrap steel raw materials according to the residual element content and the difficulty to remove the preset element, and controls the input of the residual element, in order to regulate its content. However, this method significantly limits the selection of scrap steel types for the smelting of steel types with low requirements for residual element content, and the process for classifying scrap steel described in this method can greatly increase the smelting cost and the load of manpower and material resources.

Chinese application CN110565120A discloses a method for removing and recovering Cu in molten iron containing copper. In this method, the de-copper molten salt slag system is prepared and reacted with copper-containing molten iron at high temperature to obtain Cu₂S, and the generated Cu₂S is dissolved in MS to form a sulfide molten salt electrolyte, and then the de-copper process is enhanced by applying a DC electric field. However, the copper removal method is obviously not suitable for large-scale industrial production, and needs large heat and electricity consumption.

### SUMMARY

There are many methods to overcome “copper brittleness” in prior art which is the technical problems to be solved by the present disclosure, but there are various defects in these methods. The low efficiency of Cu removing in molten steel, increasing carbon emission are solved by reducing the residual elements in the molten steel with dilution, adding alloy elements combined with cold rolling and hot rolling can solve the problem of curing the symptom, not the disease, and the unrealistic situation is solved by source control, and the problem of high cost and low efficiency can be solved by chemical copper removal.

In order to solve the above technical problems, the present disclosure provides the following technical solutions:

A method for efficiently removing Cu in the electric furnace steelmaking with regenerated steel raw materials, including removing Cu in electric furnace steelmaking; and removing Cu deeply in Ruhrstahl Heraeus/Vacuum Oxygen Decarburization (RH/VOD) steelmaking; wherein the removing Cu in the electric furnace steelmaking is removing Cu by spraying CaO—CaCl₂—O₂ in stages during the electric furnace steelmaking.

The removing Cu deeply in the RH/VOD steelmaking includes removing Cu deeply by dynamically spraying CaCl₂—O₂ based on vacuum degree.

Preferably, the removing Cu by spraying CaO—CaCl₂—O₂ in stages includes: firstly spraying the CaO powder into the electric furnace with O₂ as the carrier gas, then spraying the CaO and CaCl₂ mixed powder into the electric furnace with O₂ as the carrier gas, and finally reducing the spraying rate of the CaO and CaCl₂ mixed powder and the oxygen gas flow rate.

Preferably, the CaO powder is sprayed into the electric furnace with O₂ as the carrier gas; wherein: using O₂ as the carrier gas can form a high oxygen potential micro-region in the molten pool, which provides good thermodynamic conditions for removing Cu elements; spraying CaO powder can maintain the basicity of slag and further promote the removal of Cu element.

Preferably, the removing Cu deeply in the RH steelmaking includes: firstly spraying the CaCl₂ powder with O₂ as the carrier gas, and then spraying continuously at a higher spraying rate of the CaCl₂ powder, and finally using residual CaCl₂) powder in molten steel to further remove Cu.

Preferably, the removing Cu deeply in VOD steelmaking includes: firstly spraying the CaCl₂ powder into ladle powder with O₂ as the carrier gas, and then spraying continuously at a higher spraying rate of the CaCl₂ powder, and then stopping spraying based on an oxygen concentration potential, a vacuum degree and an exhaust gas temperature, and finally using residual CaCl₂ powder in molten steel to further remove Cu.

Preferably, the high vacuum environment in the deep Cu removal process in the RH/VOD steelmaking can effectively reduce the partial pressure of Cu chlorides, accelerate the progress of Cu removal reactions and the discharge of Cu chlorides in molten steel, and then achieve an effect of deep Cu removal.

Preferably, the Cu removing uses embedded lances to spray powder, and the an outlet of the lance is located in the molten pool, about 100-900 mm away from a molten steel surface after the scrap steel is melted, and the acute angle between the lance and a wall of the electric furnace is greater than 20°. The powder sprayed by the embedded lances can strengthen the stirring of the molten pool, thereby breaking the kinetic barrier of traditional slag-steel interface reaction and mass transfer, and providing good kinetic reaction conditions for the removal of Cu element in steel. For the quantum electric furnace, the top-blowing method can also be used for blowing.

Preferably, the removing Cu in the electric furnace steelmaking includes the following steps:
S1. when a temperature of a molten pool is increased to 1480° C., spraying CaO powder into an electric furnace with O₂ as a carrier gas; wherein a spraying rate of CaO powder is 30-60 kg/min, and an oxygen gas flow rate is 300-900 Nm³/h;
S2. when the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 70%-90%, and a spraying rate of the CaO and CaCl₂ mixed powder is increased to 40-80 kg/min, and the oxygen gas flow rate is increased to 400-1100 Nm³/h; and
S3. when the temperature of the molten pool is a tapping temperature of 1600° C., reducing the spraying rate of the CaO and CaCl₂ mixed powder and the oxygen gas flow rate, adjusting the proportion of CaCl₂ powder in the CaO and CaCl₂ mixed powder to 10%-30%, reducing the spraying rate of the CaO and CaCl₂ mixed powder to 20-60 kg/min, and reducing the oxygen gas flow rate to 200-900 Nm³/h.

Preferably, the removing Cu deeply in the RH steelmaking includes the following steps:
S1. vacuumizing to 7-10 kPa, spraying the CaCl₂ powder through a top lance with O₂ as the carrier gas at the oxygen gas flow rate of 1000-2000 Nm³/h, the spraying rate of the CaCl₂ powder of 0.04-0.05 kg/(min·t), and an argon gas flow rate of 50-80 Nm³/h, and degassing for 2-3 min;
S2. vacuumizing to less than or equal to 3 kPa, spraying CaCl₂—O₂ at the spraying rate of 0.06-0.08 kg/(min·t), the oxygen gas flow rate of 1500-2500 Nm³/h, and the argon gas flow rate of 50-80 Nm³/h, and stopping blowing after cycle degassing for 5-10 min; and
S3. after stopping blowing, vacuumizing to less than or equal to 140 Pa, increasing the argon gas flow rate to 90-120 Nm³/h, and cycle degassing for 10-15 min, and using residual CaCl₂ powder in the molten steel to further remove Cu.

Preferably, the removing Cu deeply in the VOD steelmaking includes the following steps:
S1. when vacuumizing to 20-25 kPa, spraying the CaCl₂ powder into the ladle powder through a top lance with O₂ as the carrier gas, wherein the oxygen gas flow rate is 1000-1400 Nm³/h, the spraying rate of the CaCl₂ powder is 0.04-0.055 kg/(min·t), an argon gas flow rate is 30-40 NL/min, and a spraying time is 2-3 min;
S2. vacuumizing to 3-10 kPa, increasing the spraying rate of the CaCl₂ powder to 0.05-0.07 kg/(min·t), increasing the oxygen gas flow rate to 1500-2000 Nm³/h, an argon gas flow rate remaining unchanged, and continuing spraying;
S3. monitoring the oxygen concentration potential, the vacuum degree and the exhaust gas temperature in real time; when the oxygen concentration potential is zero and the vacuum degree and the exhaust gas temperature begin to decrease, stopping blowing; and
S4. after stopping blowing, vacuumizing quickly to less than or equal to 200 Pa, increasing the argon gas flow rate to 50-60 NL/min, and keeping for 5-15 min, and using the residual CaCl₂ powder in the molten steel to further remove Cu.

Preferably, particle sizes of the CaO powder and the CaCl₂ powder are both less than 2 mm.

Preferably, in the method for efficiently removing Cu in the electric furnace steelmaking with regenerated steel raw materials, Cu can be removed effectively in the electric furnace-refining process, and the final Cu removal rate reaches 40-70%.

Preferably, the method is suitable for 50t-350t “Electric Arc Furnace (EAF)+RH/VOD” short process steelmaking.

Compared with the prior art, the present disclosure has the following beneficial effects:

In the above embodiments, the present disclosure provides a method for efficiently removing Cu in the electric furnace steelmaking with regenerated steel raw materials. Based on the principle of Cu removal in high oxygen potential micro-zones by selective gasification, CaO—CaCl₂—O₂ is sprayed in stages in the electric furnace steelmaking based on the temperature of the molten pool to remove Cu. After tapping, the system enters the RH/VOD refining station, and relying on the smelting environment of high vacuum, CaCl₂ powder is sprayed dynamically with O₂ as carrier gas under different vacuum degrees to finally further remove Cu deeply.

Since the Cu chloride produced in the Cu removal process is volatile, the present disclosure can efficiently remove and stably control the Cu element in the short-process steelmaking while not causing secondary pollution to the molten steel, and greatly eliminates the impact of Cu on the steel. The adverse effects caused by the structure and properties effectively solve the problem of cyclic enrichment of Cu in the electric furnace steelmaking with regenerated steel raw materials.

The method of the present disclosure can remove Cu efficiently in the electric furnace-refining process, and the final Cu removal rate reaches 40-70%.

In summary, the present disclosure makes high oxygen potential micro-regions in the electric furnace steelmaking molten pool and RH/VOD refining steel liquid surface and makes full use of the smelting environment of high vacuum degree in the RH/VOD refining process, and Cu removing and removing Cu deeply are performed based on the principle of selective chlorination and Cu removal, respectively in the electric furnace steelmaking and in the RH/VOD refining process; this method is low in cost and high in copper removal efficiency, which is conducive to large-scale industrial production and promotion.

### BRIEF DESCRIPTION OF THE DRAWINGS

In order to more clearly illustrate the technical solutions in the embodiments of the present disclosure, the drawings that need to be used in the description of the embodiments will be briefly introduced below. Obviously, the drawings in the following description are only some embodiments of the present disclosure. For those skilled in the art, other drawings can also be obtained based on these drawings without creative effort.

FIG. 1 is a schematic flow diagram showing a method for efficiently removing Cu in the electric furnace steelmaking with regenerated steel raw materials according to an embodiment of the present disclosure; wherein: 1 is a gas tank, 2 is a CaCl₂ powder silo, 3 is a CaO powder silo, 4 is a powder spraying pipe, 5 is an electric furnace body, 6 is a top-blown lance, 7 is an embedded lance, 8 is a VOD refining device, 9 is a carbon-oxygen lance, 10 is a ladle, 11 is a carbon-oxygen lance, and 12 is a RH refining device.

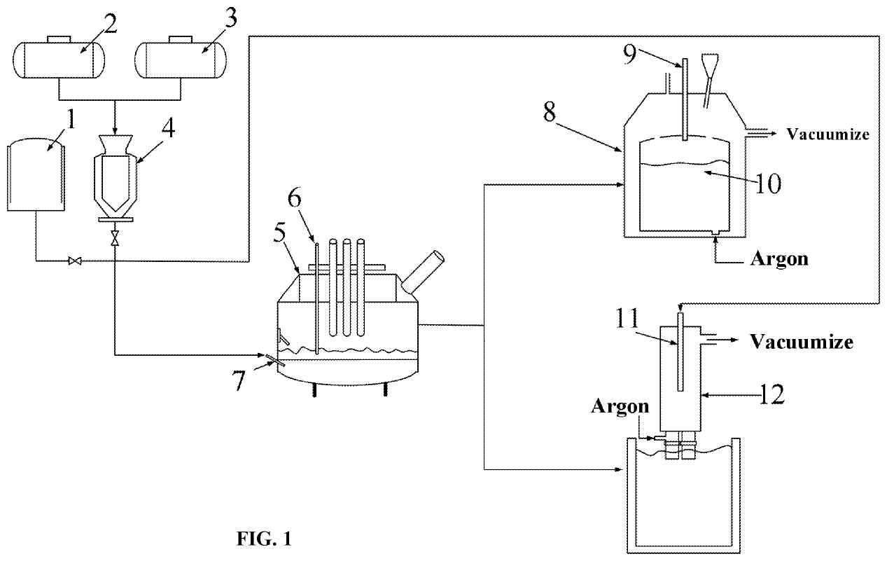

### DETAILED DESCRIPTION OF EMBODIMENTS

The technical solutions and technical problems solved in the embodiments of the present disclosure will be described below in conjunction with the embodiments of the present disclosure. Apparently, the described embodiments are only some of the embodiments of the present disclosure, not all of them.

### Embodiment 1

A method for efficiently removing Cu in the electric furnace steelmaking of the regenerated steel raw materials in this embodiment uses the 80t “EAF+RH” low-carbon steel smelting process, and the CaCl₂ powder and CaO powder used in the smelting process have a particle size of less than 1 mm. 2 embedded spraying lances are used, the depth of the lance is 500 mm below the molten steel surface, the acute angle between the lance and a wall of an electric furnace is 50 degrees, and the an outlet of the lance is facing downward. The specific smelting method includes the following steps:

1. Removing Cu in electric furnace steelmaking:
S1. When a temperature of a molten pool is increased to 1480° C., spraying CaO powder into the electric furnace with O₂ as a carrier gas; wherein a spraying rate of the CaO powder is 50 kg/min, and an oxygen gas flow rate is 600 Nm³/h;
S2. When the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 80%, and the spraying rate of the mixed powder is increased to 60 kg/min, and the oxygen gas flow rate is increased to 800 Nm³/h;
S3. When the temperature of the molten pool is a tapping temperature of 1600° C., reducing the spraying rate of the CaO and CaCl₂ mixed powder and the oxygen gas flow rate, wherein the proportion of CaCl₂ powder is adjusted to 20%, and the spraying rate of the CaO and CaCl₂ mixed powder is reduced to 25 kg/min, the oxygen gas flow rate is reduced to 600 Nm³/h;

2. Removing Cu deeply in RH steelmaking:
S1. Vacuumizing to 7 kPa, spraying CaCl₂ powder through a top lance with O₂ as the carrier gas, the oxygen gas flow rate is 1500 Nm³/h, the spraying rate of the CaCl₂ powder is 0.04 kg/(min·t), and the argon gas flow rate is 60 Nm³/h, and degassing for 3 min;
S2. Vacuumizing to less than or equal to 3 kPa, and spraying CaCl₂—O₂, with the spraying rate increased to 0.06 kg/(min·t), the oxygen gas flow rate increased to 2000 Nm³/h, an argon gas flow rate remaining unchanged, and stopping blowing after cycle degassing for 8 min;
S3. After stopping blowing, vacuumizing to less than or equal to 140 Pa, increasing the argon gas flow rate to 100 Nm³/h, and cycle degassing for 13 min, and using residual CaCl₂ powder in the molten steel to further remove Cu.

The method of this embodiment can remove Cu efficiently in the electric furnace-refining process, and the final Cu removal rate reaches 45%.

### Embodiment 2

A method for efficiently removing Cu in the electric furnace steelmaking of the regenerated steel raw materials in this embodiment uses the 100t “EAF+RH” low-carbon steel smelting process, and the CaCl₂ powder and CaO powder used in the smelting process have a particle size of less than 2 mm. One embedded lance is used, the embedded depth is 600 mm below the molten steel surface, the acute angle between the lance and a wall of the electric furnace is 60 degrees, and the an outlet of the lance is facing downward. The specific smelting method includes the following steps:

1. Removing Cu in electric furnace steelmaking:
S1. When a temperature of a molten pool is increased to 1480° C., spraying CaO powder into the electric furnace with O₂ as a carrier gas; wherein a spraying rate of the CaO powder is 60 kg/min, and an oxygen gas flow rate is 800 Nm³/h;
S2. When the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 85%, and the spraying rate of the CaO and CaCl₂ mixed powder is increased to 70 kg/min, and the oxygen gas flow rate is increased to 900 Nm³/h;
S3. When the temperature of the molten pool is a tapping temperature of 1600° C., reducing the spraying rate of CaO and CaCl₂ mixed powder and the oxygen gas flow rate, wherein the proportion of CaCl₂ powder in the CaO and CaCl₂ mixed powder is adjusted to 25%, and the spraying rate of the CaO and CaCl₂ mixed powder is reduced to 30 kg/min, the oxygen gas flow rate is reduced to 500 Nm³/h;

2. Removing Cu deeply in RH steelmaking:
S1. Vacuumizing to 8 kPa, spraying CaCl₂ powder through a top lance with O₂ as carrier gas, the oxygen gas flow rate is 1700 Nm³/h, the spraying rate of CaCl₂) powder is 0.045 kg/(min·t), and the argon gas flow rate is 70 Nm³/h, and degassing for 2 min;
S2. Vacuumizing to less than or equal to 3 kPa, and spraying CaCl₂—O₂, with the spraying rate increased to 0.07 kg/(min·t), the oxygen gas flow rate increased to 2200 Nm³/h, an argon gas flow rate remaining unchanged, and stopping blowing after cycle degassing for 10 min;
S3. After stopping blowing, vacuumizing to less than or equal to 140 Pa, increasing the argon gas flow rate to 120 Nm³/h, and cycle degassing for 15 min, and using residual CaCl₂ powder in the molten steel to further remove Cu.

The method of this embodiment can remove Cu efficiently in the electric furnace-refining process, and the final Cu removal rate reaches 50%.

### Embodiment 3

A method for efficiently removing Cu in the electric furnace steelmaking of the regenerated steel raw materials in this embodiment uses the 150t “EAF+RH” low-carbon steel smelting process, and the CaCl₂ powder and CaO powder used in the smelting process have a particle size of less than 2 mm. 3 an embedded lance is used, all of which are embedded at a depth of 550 mm below the molten steel surface, and the acute angle between the lance and a wall of the electric furnace is 70 degrees, and the an outlet of the lance is facing downward. The specific smelting method includes the following steps:

1. Removing Cu in electric furnace steelmaking:
S1. When a temperature of a molten pool is increased to 1480° C., spraying CaO powder into the electric furnace with O₂ as a carrier gas; wherein a spraying rate of CaO powder is 40 kg/min, and an oxygen gas flow rate is 500 Nm³/h;
S2. When the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 90%, and the spraying rate of the CaO and CaCl₂ mixed powder is increased to 50 kg/min, and the oxygen gas flow rate is increased to 600 Nm³/h;
S3. When the temperature of the molten pool is a tapping temperature of 1600° C., reducing the spraying rate CaO and CaCl₂ mixed powder and the oxygen gas flow rate, wherein the proportion of CaCl₂ powder in the CaO and CaCl₂ mixed powder is adjusted to 15%, and the spraying rate of the CaO and CaCl₂ mixed powder is reduced to 40 kg/min, the oxygen gas flow rate is reduced to 300 Nm³/h;

2. Removing Cu deeply in RH steelmaking:
S1. Vacuumizing to 9 kPa, spraying CaCl₂ powder through a top lance with O₂ as the carrier gas, wherein the oxygen gas flow rate is 1500 Nm³/h, the spraying rate of CaCl₂ powder is 0.05 kg/(min·t), and the argon gas flow rate is 60 Nm³/h, and degassing for 3 min;
S2. Vacuumizing to less than or equal to 3 kPa, and spraying CaCl₂—O₂, with the spraying rate increased to 0.07 kg/(min·t), wherein the oxygen gas flow rate increased to 1900 Nm³/h, an argon gas flow rate remaining unchanged, and stopping blowing after cycle degassing for 8 min;
S3. After stopping blowing, vacuumizing to less than or equal to 140 Pa, increasing the argon gas flow rate to 80 Nm³/h, and cycle degassing for 12 min, and using residual CaCl₂ powder in the molten steel to further remove Cu.

The method of this embodiment can remove Cu efficiently in the electric furnace-refining process, and the final Cu removal rate reaches 60%.

### Embodiment 4

A method for efficiently removing Cu in the electric furnace steelmaking of the regenerated steel raw materials in this embodiment uses the 150t “quantum electric furnace+VOD” low-carbon steel smelting process, and the CaCl₂ powder and CaO powder used in the smelting process have a particle size of less than 1 mm. 1 top-blown lance is used. The specific smelting method includes the following steps:

1. Removing Cu in quantum electric furnace steelmaking:
S1. When a temperature of a molten pool is increased to 1480° C., spraying CaO powder into an electric furnace with O₂ as a carrier gas; wherein a spraying rate of the CaO powder is 40 kg/min, and an oxygen gas flow rate is 700 Nm³/h;
S2. When the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 90%, and the spraying rate of the mixed powder is increased to 70 kg/min, and the oxygen gas flow rate is increased to 1000 Nm³/h;
S3. When the temperature of the molten pool is a tapping temperature of 1600° C., reducing spraying rate and oxygen gas flow rate of CaO and CaCl₂ mixed powder, wherein the proportion of CaCl₂ powder in the CaO and CaCl₂ mixed powder is adjusted to 10%, and the spraying rate of the CaO and CaCl₂ mixed powder is reduced to 35 kg/min, the oxygen gas flow rate is reduced to 600 Nm³/h;

2. Removing Cu deeply in VOD steelmaking:
S1. When vacuumizing to 22 kPa, spraying CaCl₂ powder into the ladle powder through a top lance with O₂ as carrier gas. The oxygen gas flow rate is 1200 Nm³/h, and the spraying rate of CaCl₂ powder is 0.055 kg/(min·t), an argon gas flow rate is 35 NL/min, and a spraying time is 3 min.
S2. Vacuumizing to 5 kPa, increasing the spraying rate of CaCl₂ powder to 0.06 kg/(min·t), increasing the oxygen gas flow rate to 1800 Nm³/h, remaining the argon gas flow rate unchanged, and continuing spraying.
S3. Monitoring the oxygen concentration potential, the vacuum degree and the exhaust gas temperature in real time; when the oxygen concentration potential is zero and the vacuum degree and the exhaust gas temperature begin to decrease, stopping blowing.
S4. After stopping blowing, vacuumizing quickly to less than or equal to 200 Pa, increasing the argon gas flow rate to 50 NL/min, and keeping for 10 min, and using residual CaCl₂ powder in the molten steel to further remove Cu.

The method of this embodiment can remove Cu efficiently in the electric furnace-refining process, and the final Cu removal rate reaches 40%.

### Embodiment 5

A method for efficiently removing Cu in the electric furnace steelmaking of the regenerated steel raw materials in this embodiment uses the 200t “quantum electric furnace+VOD” low-carbon steel smelting process. The CaCl₂ powder and CaO powder used in the smelting process have a particle size of less than 2 mm. 1 top-blown lance is used. The specific smelting method includes the following steps:

1. Removing Cu in quantum electric furnace steelmaking:
S1. When a temperature of a molten pool is increased to 1480° C., spraying CaO powder into an electric furnace with O₂ as a carrier gas; wherein a spraying rate of CaO powder is 50 kg/min, and an oxygen gas flow rate is 800 Nm³/h;
S2. When the temperature of the molten pool is increased to 1540° C., spraying CaO and CaCl₂ mixed powder into the electric furnace with O₂ as carrier gas; wherein a proportion of CaCl₂ powder in the CaO and CaCl₂ mixed powder is 80%, and the spraying rate of the CaO and CaCl₂ mixed powder is increased to 60 kg/min, and the oxygen gas flow rate is increased to 1000 Nm³/h;
S3. When the temperature of the molten pool is a tapping temperature of 1600° C., reducing a spraying rate of the CaO and CaCl₂ mixed powder and an oxygen gas flow rate, wherein the proportion of CaCl₂ powder in the CaO and CaCl₂ mixed powder is adjusted to 20%, and the spraying rate of the CaO and CaCl₂ mixed powder is reduced to 40 kg/min, the oxygen gas flow rate is reduced to 700 Nm³/h;

2. Removing Cu deeply in VOD steelmaking:
S1. When vacuumizing to 23 kPa, spraying CaCl₂ powder into the ladle powder through a top lance with O₂ as carrier gas. The oxygen gas flow rate is 1300 Nm³/h, the spraying rate of CaCl₂ powder is 0.05 kg/(min·t), an argon gas flow rate is 40NL/min, and a spraying time is 3 min;
S2. Vacuumizing to 6 kPa, increasing the spraying rate of CaCl₂ powder to 0.055 kg/(min·t), increasing the oxygen gas flow rate to 1900 Nm³/h, remaining the argon gas flow rate unchanged, and continuing spraying;
S3. Monitoring the oxygen concentration potential, the vacuum degree and the exhaust gas temperature in real time; when the oxygen concentration potential is zero and the vacuum degree and the exhaust gas temperature begin to decrease, stopping blowing;
S4. After stopping blowing, vacuumizing quickly to less than or equal to 200 Pa, increasing the argon gas flow rate to 55 NL/min, and keeping for 10 min, and using residual CaCl₂ powder in the molten steel to further remove Cu.

The method of this embodiment can remove Cu efficiently in the electric furnace-refining process, and the final Cu removal rate reaches 50%.

### Embodiment 6

A method for efficiently removing Cu in the electric furnace steelmaking of the regenerated steel raw materials in this embodiment uses the 300t “quantum electric furnace+VOD” low-carbon steel smelting process, and the CaCl₂ powder and CaO powder used in the smelting process have a particle size of less than 1 mm. 1 top-blown lance is used. The specific smelting method includes the following steps:

1. Removing Cu in quantum electric furnace steelmaking:
S1. When a temperature of a molten pool is increased to 1480° C., spraying CaO powder into an electric furnace with O₂ as a carrier gas; wherein a spraying rate of CaO powder is 60 kg/min, and an oxygen gas flow rate is 900 Nm³/h;
S2. When the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 85%, and the spraying rate of the CaO and CaCl₂ mixed powder is increased to 80 kg/min, and the oxygen gas flow rate is increased to 1100 Nm³/h;
S3. When the temperature of the molten pool is 1600° C. which is tapping temperature, reducing a spraying rate of the CaO and CaCl₂ mixed powder and an oxygen flow rate, wherein the proportion of CaCl₂ powder in the CaO and CaCl₂) mixed powder is adjusted to 30%, and the spraying rate of the CaO and CaCl₂ mixed powder is reduced to 60 kg/min, the oxygen gas flow rate is reduced to 800 Nm³/h;

2. Removing Cu deeply in VOD steelmaking:
S1. When vacuumizing to 25 kPa, spraying CaCl₂ powder into the ladle powder through a top lance with O₂ as the carrier gas. The oxygen gas flow rate is 1400 Nm³/h, the spraying rate of CaCl₂ powder is 0.055 kg/(min·t), an argon gas flow rate is 40 NL/min, and a spraying time is 3 min;
S2. Vacuumizing to 10 kPa, increasing the spraying rate of CaCl₂ powder to 0.07 kg/(min·t), increasing the oxygen gas flow rate to 2000 Nm³/h, remaining the argon gas flow rate unchanged, and continuing spraying;
S3. Monitoring the oxygen concentration potential, the vacuum degree and the exhaust gas temperature in real time; when the oxygen concentration potential is zero and the vacuum degree and the exhaust gas temperature begin to decrease, stopping blowing;
S4. After stopping blowing, vacuumizing quickly to less than or equal to 200 Pa, increasing the argon gas flow rate to 60 NL/min, and keeping for 15 min, and using residual CaCl₂ powder in the molten steel to further remove Cu.

The method of this embodiment can remove Cu efficiently in the electric furnace-refining process, and the final Cu removal rate reaches 60%.

In the above embodiments, the present disclosure provides a method for efficiently removing Cu in the electric furnace steelmaking with regenerated steel raw materials. Based on the principle of Cu removal in high oxygen potential micro-zones by selective gasification, CaO—CaCl₂—O₂ is sprayed in stages in the electric furnace steelmaking based on the temperature of the molten pool to remove Cu. After tapping, the system enters the RH/VOD refining station, and relying on the smelting environment of high vacuum, CaCl₂ powder is sprayed dynamically with O₂ as carrier gas under different vacuum degrees to finally further remove Cu deeply.

Since the Cu chloride produced in the Cu removal process is volatile, the present disclosure can efficiently remove and stably control the Cu element in the short-process steelmaking while not causing secondary pollution to the molten steel, and greatly eliminates the adverse effects caused by the structure and properties of Cu, effectively solves the problem of cyclic enrichment of Cu in the electric furnace steelmaking with regenerated steel raw materials.

The method of the present disclosure can remove Cu efficiently in the electric furnace-refining process, and the final Cu removal rate reaches 40-70%.

In summary, the present disclosure makes high oxygen potential micro-regions in the electric furnace steelmaking molten pool and RH/VOD refining steel liquid surface and makes full use of the smelting environment of high vacuum degree in the RH/VOD refining process, and Cu removing and removing Cu deeply are performed based on the principle of selective chlorination and Cu removal, respectively in the electric furnace steelmaking and in the RH/VOD refining process; this method is low in cost and high in copper removal efficiency, which is conducive to large-scale industrial production and promotion.

The above description is a preferred embodiment of the present disclosure, it should be pointed out that for those of ordinary skill in the art, without departing from the principle of the present disclosure, some improvements and modifications can also be made. These improvements and modifications should also be regarded as the protection scope of the present disclosure.

What is claimed is:

1. A method for efficiently removing Cu in electric furnace steelmaking with regenerated steel raw materials, comprising:
removing Cu in the electric furnace steelmaking; and
removing Cu deeply in Ruhrstahl Heraeus/Vacuum Oxygen Decarburization (RH/VOD) steelmaking; wherein
the removing Cu in the electric furnace steelmaking comprises removing Cu by spraying CaO—CaCl₂—O₂ in stages during the electric furnace steelmaking; and
the removing Cu deeply in the RH/VOD steelmaking comprises removing Cu deeply by dynamically spraying CaCl₂—O₂ based on vacuum degree;
wherein the removing Cu in the electric furnace steelmaking specifically comprises the following steps:
S1. when a temperature of a molten pool is increased to 1480° C., spraying CaO powder into an electric furnace with O₂ as a carrier gas; wherein a spraying rate of the CaO powder is 30-60 kg/min, and an oxygen gas flow rate is 300-900 Nm³/h;
S2. when the temperature of the molten pool is increased to 1540° C., spraying CaO and CaCl₂ mixed powder into the electric furnace with O₂ as the carrier gas; wherein a proportion of CaCl₂ powder in the CaO and CaCl₂ mixed powder is 70%-90%, and a spraying rate of the CaO and CaCl₂ mixed powder is increased to 40-80 kg/min, and the oxygen gas flow rate is increased to 400-1100 Nm³/h; and
S3. when the temperature of the molten pool is a tapping temperature of 1600° C., reducing the spraying rate of the CaO and CaCl₂ mixed powder and the oxygen gas flow rate, adjusting the proportion of CaCl₂ powder in the CaO and CaCl₂ mixed powder to 10%-30%, reducing the spraying rate of the CaO and CaCl₂ mixed powder to 20-60 kg/min, and reducing the oxygen gas flow rate to 200-900 Nm³/h.

2. The method according to claim 1, wherein the removing Cu by spraying CaO—CaCl₂—O₂ in stages comprises: firstly spraying the CaO powder into the electric furnace with O₂ as the carrier gas, then spraying the CaO and CaCl₂ mixed powder into the electric furnace with O₂ as the carrier gas, and finally reducing the spraying rate of the CaO and CaCl₂ mixed powder and the oxygen gas flow rate.

3. The method according to claim 1, wherein the removing Cu deeply in the RH steelmaking comprises: firstly spraying the CaCl₂ powder with O₂ as the carrier gas, and then spraying continuously at a higher spraying rate of the CaCl₂ powder, and finally using residual CaCl₂ powder in molten steel to further remove Cu.

4. The method according to claim 1, wherein the removing Cu deeply in the VOD steelmaking comprises: firstly spraying the CaCl₂ powder into ladle powder with O₂ as the carrier gas, and then spraying continuously at a higher spraying rate of the CaCl₂ powder, and then stopping spraying based on an oxygen concentration potential, a vacuum degree and an exhaust gas temperature, and finally using residual CaCl₂ powder in molten steel to further remove Cu.

5. The method according to claim 1, wherein an embedded lance is used to spray powder to remove Cu, and an outlet of the lance is located in the molten pool and 100-900 mm away from a molten steel surface after scrap steel is melted, and an acute angle between the lance and a wall of the electric furnace is greater than 20°.

6. The method according to claim 3, wherein the removing Cu deeply in the RH steelmaking comprises the following steps:
S1. vacuumizing to 7-10 kPa, spraying the CaCl₂ powder through a top lance with O₂ as the carrier gas at the oxygen gas flow rate of 1000-2000 Nm³/h, the spraying rate of the CaCl₂ powder of 0.04-0.05 kg/(min·t), and an argon gas flow rate of 50-80 Nm³/h, and degassing for 2-3 min;
S2. vacuumizing to less than or equal to 3 kPa, spraying CaCl₂—O₂ at the spraying rate of 0.06-0.08 kg/(min·t), the oxygen gas flow rate of 1500-2500 Nm³/h, and the argon gas flow rate of 50-80 Nm³/h, and stopping blowing after cycle degassing for 5-10 min; and
S3. after stopping blowing, vacuumizing to less than or equal to 140 Pa, increasing the argon gas flow rate to 90-120 Nm³/h, and cycle degassing for 10-15 min, and using residual CaCl₂ powder in the molten steel to further remove Cu.

7. The method according to claim 4, wherein the removing Cu deeply in VOD steelmaking specifically comprises the following steps:
S1. when vacuumizing to 20-25 kPa, spraying the CaCl₂ powder into the ladle powder through a top lance with O₂ as the carrier gas, wherein the oxygen gas flow rate is 1000-1400 Nm³/h, the spraying rate of the CaCl₂ powder is 0.04-0.055 kg/(min·t), an argon gas flow rate is 30-40 NL/min, and a spraying time is 2-3 min;
S2. vacuumizing to 3-10 kPa, increasing the spraying rate of the CaCl₂ powder to 0.05-0.07 kg/(min·t), increasing the oxygen gas flow rate to 1500-2000 Nm³/h, the argon gas flow rate remaining unchanged, and continuing spraying;
S3. monitoring the oxygen concentration potential, the vacuum degree and the exhaust gas temperature in real time; when the oxygen concentration potential is zero and the vacuum degree and the exhaust gas temperature begin to decrease, stopping blowing; and
S4. after stopping blowing, vacuumizing quickly to less than or equal to 200 Pa, increasing the argon gas flow rate to 50-60 NL/min, and keeping for 5-15 min, and using the residual CaCl₂ powder in the molten steel to further remove Cu.

8. The method according to claim 1, wherein particle sizes of the CaO powder and the CaCl₂ powder are both less than 2 mm.

9. The method according to claim 1, wherein the method is suitable for 50 t-350 t “Electric Arc Furnace (EAF)+RH/VOD” short-process steelmaking.
